(19) United States
(12) Patent Application Publication
(10) Pub. No.: US 2025/0290355 A1
(43) Pub. Date: Sep. 18, 2025

(54) CINCH ACTUATOR HAVING CYCLOIDAL DRIVE

(71) Applicant: MAGNA CLOSURES INC., Newmarket (CA)

(72) Inventors: Csaba SZENTE, Newmarket (CA); John DISTEFANO, Newmarket (CA); Amandeep KALRA, Newmarket (CA); Pranavan SUHINDAN, Newmarket (CA)

(21) Appl. No.: 19/074,315

(22) Filed: Mar. 7, 2025

Related U.S. Application Data
(60) Provisional application No. 63/564,605, filed on Mar. 13, 2024.

(51) Int. Cl. E05B 81/20; E05B 79/20; E05B 81/06; E05B 81/18; E05B 81/30; E05B 81/34; E05B 81/42

(52) U.S. Cl. CPC E05B 81/20; E05B 79/20; E05B 81/06; E05B 81/18; E05B 81/30; E05B 81/34; E05B 81/42

(57) ABSTRACT

A cinch power actuator for a closure latch assembly of a vehicle closure member includes a motor, an output gear configured to be driven in response to energization of the motor, a cam fixed to output gear for eccentric rotation about a rotational axis of output gear, a cycloid disk configure to be driven in eccentric fashion by the cam, and an output disk configured to be driven about the rotational axis of output gear by the cycloid disk, wherein the output disk is configured to drive a cable to move a ratchet of the closure latch assembly from a secondary striker capture position to a primary striker capture position.

### CROSS-REFERENCE TO RELATED APPLICATION

This application claims the benefit of U.S. Provisional Application Ser. No. 63/564,605, filed Mar. 13, 2024, which is incorporated herein by reference in its entirety.

### FIELD

The present disclosure relates generally to closure latches for a vehicle closure panels. More particularly, the present disclosure is directed to a vehicle closure latch equipped with a cinch mechanism.

### BACKGROUND

This section provides background information related to closure latches and is not necessarily prior art to the closure latch of the present disclosure.

Many modern closure latches provide various power-operated features including power release, power lock and power cinch functions. Power cinch, also referred to as “soft close,” completes closure of a vehicle door if the vehicle door is only partially closed. Typically, cinch mechanisms have one or more gear reductions configured in operably driven communication with a power actuator, wherein the gear reduction(s) is drives one or more levers arranged to drive a ratchet from a partially closed position to a cinched position. Although known lever driven cinch mechanisms are well suited for their intended use, they come with drawbacks. For example, the gear reduction(s) and lever(s) have numerous interacting components, which introduce complexity, cost and excessive backlash (play), thereby requiring a significant amount of travel, including pre-travel, to effect actuation, and thus, generate unwanted noise and can have durability issues. Further yet, gear reductions(s) and levers tend to be inefficient, with low to moderate torque capacity, thereby requiring excessive movement to effect actuation. Also, gear reductions(s) and levers typically occupy a significant amount of space, thereby increasing the package size of the latch assembly.

### SUMMARY

This section provides a general summary of the disclosure and is not intended to be considered as a comprehensive and exhaustive listing of its full scope or all of its aspects, features and objectives.

It is an aspect of the present disclosure to provide a closure latch assembly for a vehicle closure panel, with the closure latch assembly having a cinch mechanism that overcomes at least the drawbacks discussed above, thereby having low backlash, high torque capacity, high durability, high efficiency, is compact, and is quiet in operation.

A closure latch assembly for a vehicle closure member has a power actuator, a latch mechanism including a ratchet, a pawl, and a cinch mechanism having a cycloidal drive. The pawl is moveable between a ratchet holding position, whereat the pawl holds the ratchet in one of a primary and a secondary striker capture position, and a ratchet releasing position, whereat the pawl permits the ratchet to move to its striker release position. The power actuator is arranged to drive the cycloidal drive while the ratchet is in the secondary striker capture position, whereupon the cycloidal drive causes the ratchet to move from the secondary striker capture position to the primary striker capture position. In a related aspect, the closure latch assembly includes a cinch mechanism configured to move the ratchet, wherein the cycloidal drive is coupled to the cinch mechanism to cause the ratchet to move from the secondary striker capture position to the primary striker capture position.

In accordance with another aspect of the disclosure, a cinch power actuator for a closure latch assembly of a vehicle closure member includes a motor and an output gear configured to be driven in response to energization of the motor. Further, a cam is fixed to output gear for eccentric rotation about a rotational axis of output gear and a cycloid disk is configure to be driven in eccentric fashion by the cam. Further, an output disk is configured to be driven about the rotational axis of output gear by the cycloid disk, wherein the output disk is configured to drive a cable to move a ratchet of the closure latch assembly from a secondary striker capture position to a primary striker capture position.

In accordance with another aspect of the disclosure, the output disk has a slot configured for receipt of a ferrule fixed to the cable therein, wherein the ferrule is configured for lost motion within the slot as the output disk rotates about the rotational axis of the output gear, thereby allowing a buildup of inertia prior to cinching the ratchet, and for a reset operation after cinching the ratchet.

In accordance with another aspect of the disclosure, the slot has a drive end configured to engage the ferrule to pull the cable and move the ratchet from the secondary striker capture position to the primary striker capture position.

In accordance with another aspect of the disclosure, the cinch power actuator has a housing including a drive pocket configured for receipt of the cycloid disk therein, the cycloid disk have a plurality of protrusions extending radially outwardly for receipt within a plurality of notches of the drive pocket.

In accordance with another aspect of the disclosure, the cycloid disk has a plurality of pins fixed thereto and the output disk has a plurality of openings, each of the plurality of pins being disposed in a separate one of the plurality of openings.

In accordance with another aspect of the disclosure, the openings are sized for a loose, clearance fit of the pins therein.

In accordance with another aspect of the disclosure, the output disk is supported for concentric movement about the rotational axis of the output gear.

In accordance with another aspect of the disclosure, the output disk is arranged between the output gear and cycloid disk.

In accordance with another aspect of the disclosure, a bearing supports the cycloid disk for relative movement on the cam.

In accordance with another aspect of the disclosure, the bearing rotates in eccentric fashion about the rotational axis of the output gear.

In accordance with another aspect of the disclosure, a closure latch assembly for a vehicle closure member has a cinch power actuator including a motor and a cycloidal drive, a latch mechanism including a ratchet and a pawl. The ratchet being moveable between a primary striker capture position, a secondary striker capture position, and a striker release position. The pawl being moveable between a ratchet holding position, whereat the pawl holds the ratchet in one of its primary and secondary striker capture positions, and a ratchet releasing position, whereat the pawl permits the ratchet to move to its striker release position. The motor is arranged to drive the cycloidal drive while the ratchet is in the secondary striker capture position, whereupon the cycloidal drive causes the ratchet to move from the secondary striker capture position to the primary striker capture position.

In accordance with another aspect of the disclosure, the motor is arranged to drive a worm rotatably about a first axis and the cycloidal drive includes a driven gear configured to be driven rotatably about a second axis in response to rotation of the worm about the first axis, the cycloidal drive further including a cam configured to be driven conjointly with the driven gear in eccentric relation about the second axis.

In accordance with another aspect of the disclosure, the cycloidal drive includes a cycloid disk configured to be driven in eccentric relation about the second axis in response to rotation of the cam about the second axis.

In accordance with another aspect of the disclosure, the cinch power actuator has a housing including a drive pocket configured for receipt of the cycloid disk therein, the cycloid disk have a plurality of protrusions extending radially outwardly for receipt within a plurality of notches of the drive pocket.

In accordance with another aspect of the disclosure, the cycloid disk is configured to rotate eccentrically within the drive pocket.

In accordance with another aspect of the disclosure, the plurality of protrusions move into and out of the plurality of notches as the cycloid disk rotates eccentrically within the drive pocket.

In accordance with another aspect of the disclosure, the cinch power actuator has an output disk configured to be driven about the second axis by the cycloid disk, and further including a cable operably coupling the output disk to the ratchet.

In accordance with another aspect of the disclosure, the cycloid disk has a plurality of pins fixed thereto and the output disk has a plurality of openings, each of the plurality of pins being disposed in a separate one of the plurality of openings.

In accordance with another aspect of the disclosure, the output disk has a slot and the cable has a ferrule fixed thereto, the ferrule being configured for lost motion within the slot as the output disk rotates about the second axis.

In accordance with another aspect of the disclosure, the slot has a drive end configured to engage the ferrule to pull the cable and move the ratchet from the secondary striker capture position to the primary striker capture position.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1A is a partial perspective view of a motor vehicle having a side door equipped with a power latch assembly embodying the teachings of the present disclosure;

FIG. 1B is a side view of a closure member of a motor vehicle having a closure latch assembly and a cinch mechanism constructed in accordance with an aspect of the disclosure;

FIG. 1C is a perspective view of a non-limiting, example ratchet and pawl arrangement of the closure latch assembly of FIG. 1B;

FIGS. 2A and 2B are respective front and rear views of a power actuator of the cinch mechanism for the closure latch assembly of FIG. 1;

FIGS. 3A and 3B are respective left and right views of the power actuator of FIGS. 2A and 2B;

FIG. 4A is a perspective view of the power actuator of FIGS. 2A through 3B;

FIG. 4B is a top view of the power actuator of FIG. 4A with a top cover removed for clarity of internal components;

FIG. 4C is a bottom view of the power actuator of FIG. 4A with a bottom cover removed for clarity of internal components;

FIG. 4D is an exploded view of the power actuator of FIG. 4A;

FIG. 5 is an enlarged fragmentary top view of the power actuator of FIG. 4A with the top cover in transparency for clarity purposes only and an output disk removed for clarity purposes only;

FIG. 6A is a right view looking generally along the same direction as FIG. 3B illustrating a motor, drive worm, driven gear, and cam of the power actuator of FIG. 4A;

FIG. 6B is a perspective view of the driven gear, cam, and a cycloid disk of the power actuator of FIG. 4A, with the output disk removed from between the driven gear and cycloid disk for clarity purposes only;

FIG. 6C is a perspective view of the driven gear and cycloid disk with the top cover shown arranged in driving engagement with the cycloid disk, with the output disk removed from between the driven gear and cycloid disk for clarity purposes only;

FIG. 6D is a perspective view of the driven gear, cam and cycloid disk with the output disk disposed between the driven gear and cycloid disk;

FIG. 6E is a perspective view similar to FIG. 6D looking from a different perspective with a cable fixed to the output disk; and

FIG. 6F is a perspective view illustrating the cable fixed for loss motion within a slot of the output disk, with the cycloid disk removed for clarity purposes only.

### DETAILED DESCRIPTION OF EXAMPLE EMBODIMENTS

Example embodiments of a closure latch for use in motor vehicle door closure systems are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

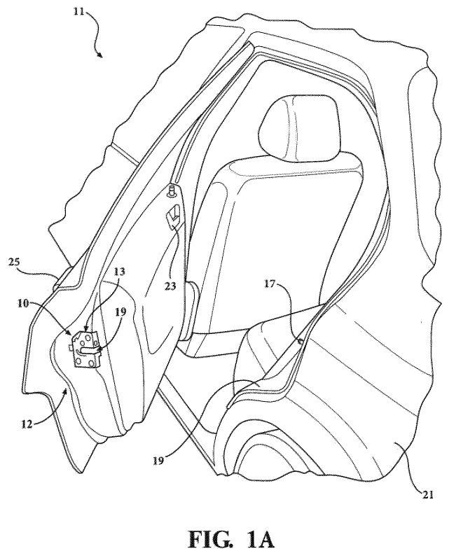

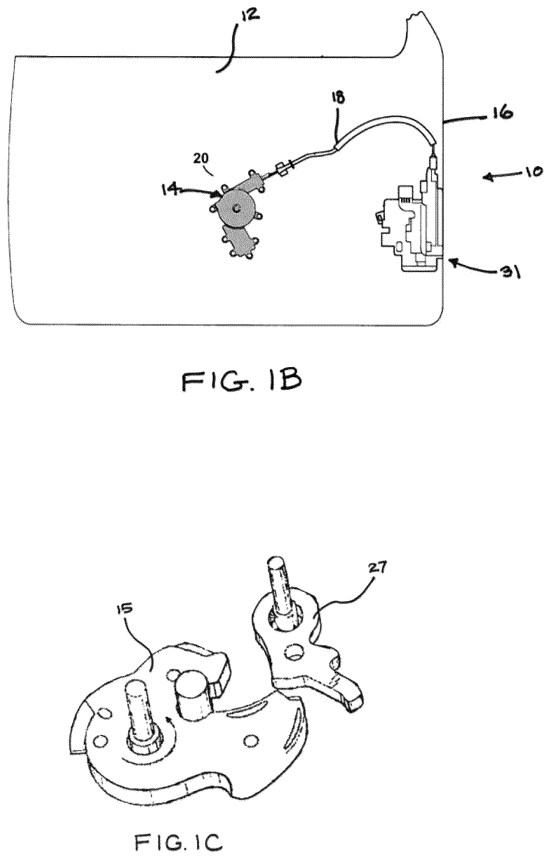

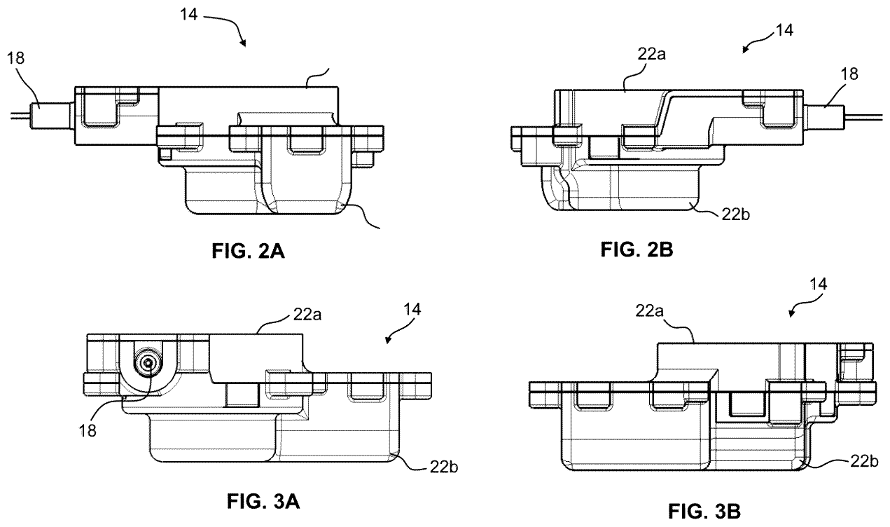

Referring initially to FIG. 1A, a non-limiting example of a power closure latch assembly, also referred to as closure latch assembly, and referred to hereafter simply as latch assembly 10, is shown installed in a shut face portion 16 of a closure member, also referred to as closure panel, such as, by way of example and without limitation, a door, shown as a passenger side swing door 12 of a motor vehicle 11. Latch assembly 10 includes a latch mechanism 13 configured for operable communication with a cinch power actuator 14 (FIG. 1B) constructed in accordance with the disclosure to cinch a ratchet 15 (FIG. 1C) of latch mechanism 13 in a cinching operation to releasably latch and hold a striker 17 mounted to a sill portion 19 of a vehicle body 21 when swing door 12 is closed. Latch assembly 10 can be selectively actuated via an inside door handle 23, an outside door handle 25, and a key fob. A pawl 27 (FIG. 1C) is moveable between a ratchet holding position, whereat the pawl 27 holds the ratchet 15 in at least one of a primary and a secondary striker capture position, and a ratchet releasing position, whereat the pawl 27 permits the ratchet 15 to move to a striker release position, whereat striker 17 can be removed from latch assembly 10 to allow swing door 12 to be moved to a fully open position (FIG. 1A), such as discussed in co-owned U.S. Patent Publication No. 2023/0167660 to Tomaszewski under U.S. patent application Ser. No. 17/988,751, filed Nov. 16, 2022, the entire disclosure of which being incorporated herein by way of reference.

When desired to move pawl 27 from the ratchet holding position to the ratchet releasing position during normal use conditions, such as when a person approaches motor vehicle 11 with electronic key fob and actuates the outside door handle 25, for example, a latch electronic control unit (ECU) that at least partially controls the operation of latch assembly 10, such as discussed in co-owned U.S. Patent Publication No. 2023/0034544 to Mozola under U.S. patent application Ser. No. 17/868,289, filed Jul. 19, 2022, the entire disclosure of which being incorporated herein by way of reference, including the cinching operation facilitated via cinch power actuator 14, sensing both the presence of key fob and that outside door handle 25 has been actuated, signals a latch power actuator to move pawl to the ratchet releasing position. Then, when desired to cinch ratchet 15 to the primary striker capture position, ECU, via communication with one or more sensors, signals cinch power actuator 14 to move ratchet to the primary striker capture position.

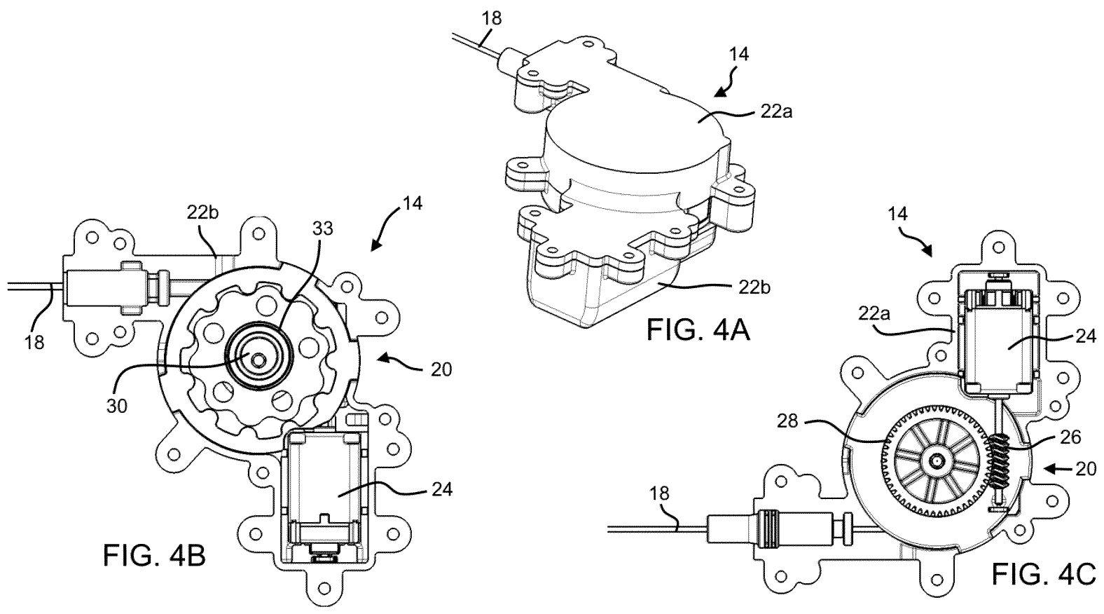

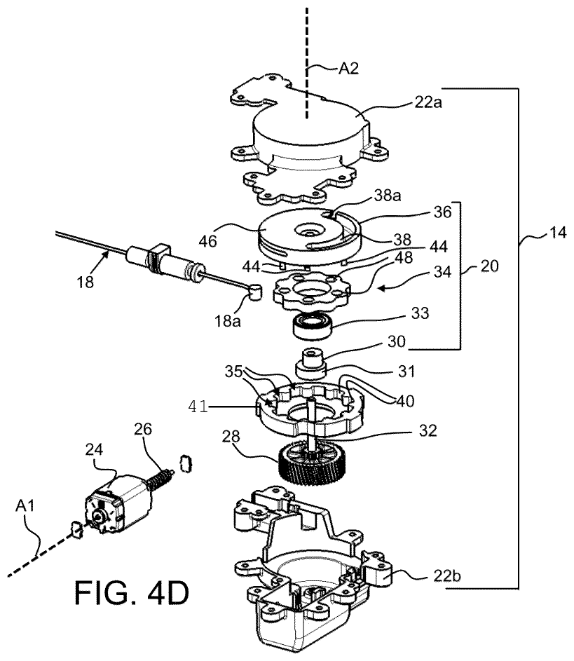

In the cinching operation, cinch power actuator, referred to hereafter as power actuator 14, is operably coupled to latch mechanism 13 via a cable 18, such as a Bowden cable (FIG. 1B). Cinch power actuator 14 includes a cinch mechanism having a cycloidal drive mechanism, referred to hereafter as cycloidal drive 20 (best shown in FIGS. 4B, 5, and 6C). The power actuator 14 is arranged to drive the cycloidal drive 20 while the ratchet 15 is in the secondary striker capture position, whereupon the cycloidal drive 20 causes the ratchet 15 to move from the secondary striker capture position to the primary striker capture position, as discussed above.

Cinch power actuator 14 can be energized via a signal from ECU based on the position of ratchet 15, by way of example and without limitation, such as when ratchet 15 reaches the secondary striker capture position from the striker release position, and can be de-energized via a signal from ECU upon completing the cinch operation. Upon reaching the overtravel position, ratchet 15 can be automatically returned to the primary striker capture position via bias imparted by ratchet biasing member, as is known and understood by a person possessing ordinary skill in the art (POSA) of motor vehicle latches.

Upon ratchet 15 being moved to the secondary striker capture position during a closure panel closing event, cinch power actuator 14 can be automatically energized via a signal from ECU, thereby causing cycloidal drive 20 to move from a home positon to a cinch position, thereby driving ratchet 15, via cable 18, from the secondary striker capture position to the cinched, overtravel position. When ratchet 15 reaches the overtravel position, cinch power actuator 14 returns cycloidal drive 20 from the cinch position to the home position.

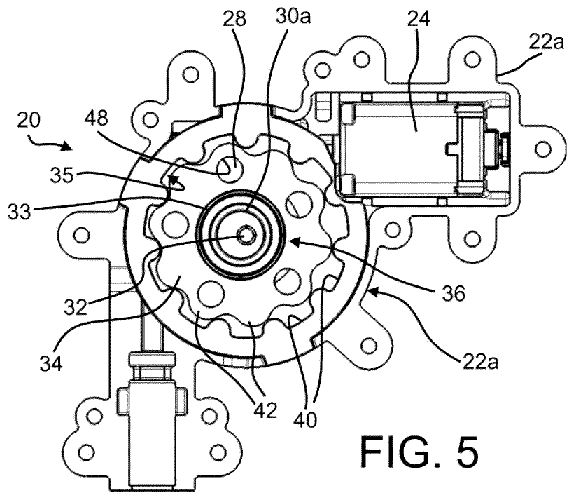

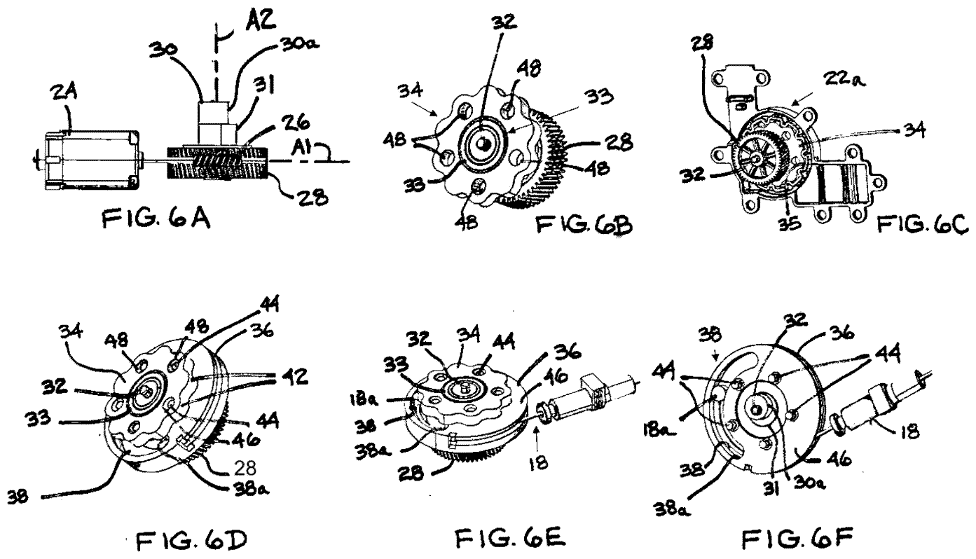

As best shown in FIG. 4, cinch power actuator 14 incudes a housing, having an upper or top cover 22a and a lower or bottom cover 22b. Housing is configured for receipt of an electric motor 24, an output gear, also referred to as driven gear 28, a cam 30, and a cycloid disk 34 therein. Motor 24 is configured to drive a drive gear, shown as a worm 26, by way of example and without limitation, about a first axis A1 (FIGS. 4D, 5, and 6A), such that driven gear 28, arranged in meshed engagement with worm 26, is caused to be driven by worm 26. Further, cam 30, being fixed to driven gear 28, is driven in conjoint rotation therewith, wherein driven gear 28 and cam 30 are supported for rotation about a second axis A2 (best shown in FIGS. 4D and 6A) by a shaft 32, wherein the first axis A1 and second axis A2 are generally transverse to one another. Further, cycloid disk 34 is supported by a bearing 33 within housing for driven rotational movement within a recessed drive pocket 35 (best shown in FIGS. 5 and 6C) of top cover 22a about second axis A2 by cam 30, as cam 30 is driven by shaft 32, driven gear 28, worm 26, and ultimately motor 24. Bearing 33 supports the cycloid disk 34 for relative movement on the cam 30, with cam 30 extending through a bore of bearing 33, and cycloid disk 34 supported on an outer surface of bearing 33. Accordingly, recessed drive pocket 35 is particularly configured for receipt of the cycloid disk 34 therein. Upon cam 30 being driven about second axis A2, an output disk 36, coupled directly to cable 18 and supported for rotation by bearing 32, is driven by cycloid disk 34 for rotation about second axis A2. In the illustrated embodiment, output disk 36 is supported for concentric movement about the second axis A2 on a journal 31 (FIGS. 4D, 6A, and 6F) concentric to second axis A2, with cam 30 extending axially outwardly from journal 31. Accordingly, output disk 36 is arranged in sandwiched relation between driven gear 28 and cycloid disk 34. As output disk 36 is driven about second axis A2 from a home position, corresponding to when ratchet 15 is in the secondary striker capture position, to a cinch position, a ferrule 18a fixed to cable 18 traverses slot 38 in lost motion until ferrule 18a engages a drive end 38a of slot 38, whereupon cable 38 is pulled to affect cinching of ratchet 15. Accordingly, cable 18 operably couples the output disk 36 to the ratchet 15. As output disk 36 continues to be driven rotatably about second axis A2 with ferrule 18a engaging drive end 38a of slot 38, cable 18 is pulled and ratchet 15 is driven via operable communication with cable 18 (e.g. cable 18 can be coupled directly or indirectly with ratchet 15 to cause movement of ratchet 15 in response to movement of cable 18) in cinching fashion from the second striker capture position to the overtravel or primary striker capture position, thereby causing door 12 to be moved to the fully closed, latched position. Upon completion of the cinching process, motor 24 is reversed via a signal from ECU, thereby reverse driving cycloid disk 34 and output disk 36 to the home position in a reset operation. During the reset operation, ferrule 18a of cable 18 is permitted to move in lost motion within slot 38 of output disk 36 away from the drive end 38a of slot 38.

As best shown in FIG. 5, recessed drive pocket 35 of top cover 22a has a plurality of radially outwardly extending drive notches, referred to hereafter as notches 40. Notches 40 may be formed on the top cover 22a, or on a chassis disk 41 secured to the top cover 22a. Notches 40 are distributed uniformly in equidistantly spaced relation from one another about an annular outer periphery, and extend radially outwardly into outer periphery bounding recessed drive pocket 35.

Cycloid disk 34 has a plurality of drive cogs, also referred to as dogs or protrusions 42 extending radially outwardly from an annular outer periphery of cycloid disk 34. The protrusions 42 are distributed uniformly in equidistantly spaced relation from one another, and correspond in same number to the number of drive notches 40.

Operation of cycloid drive 20 is generally illustrated in FIGS. 6A-6F. Motor 24 drives driven gear 28 about second axis A2 via rotation of worm 26 about first axis A1, whereupon cam 30, fixed to driven gear 28 via shaft 32, rotates conjointly in fixed relation with driven gear 28 about second axis A2. Cam 30 has an outer drive surface 30a that is eccentric relative to the rotational axis A2 of driven gear 28, wherein drive surface 30a is arrange for operable driving engagement via bearing 33 with cycloid disk 34. As such, upon rotation of cam 30 about second axis A2, drive surface 30a drives bearing 33 in eccentric relation about second axis A2, whereupon bearing 33 drives cycloid disk 34 in a corresponding eccentric relation about the rotational second axis A2 of driven gear 28.

As cycloid disk 34 is driven in eccentric fashion within recessed drive pocket 35, protrusions 42 are driven within stationary notches 40 formed in an outer periphery of the recessed drive pocket 35 (FIG. 5), thereby causing cycloid disk 34 to be driven about the circumference of recessed drive pocket 35. As cycloid disk 34 is driven eccentrically with recess drive pocket 35, protrusions 42 are caused to move into and out of stationary notches 40, as will be understood by a POSA upon viewing the disclosure herein. Output disk 36 has a plurality of pins 44 extending laterally outwardly in fixed relation from a side face 46 thereof, with pins 44 being received in a plurality openings 48 of cycloid disk 34. It is to be understood that each of the plurality of pins 44 is disposed in a separate one of the plurality of openings 48. The openings 48 are sized for a loose, clearance fit of the pins 44 therein, such that the pins 44 are able to move laterally, in transverse relation relative to the second axis A2, within the openings 48, thereby permitting the eccentric movement of the cycloid disk 34 relative to the second axis A2, while maintaining the rotation of output disk 36 in concentric relation about the second axis A2. As such, as cycloid disk 34 is driven about the periphery of recessed pocket 35, the pins 44 are driven by cycloid disk 34, thereby causing output disk 36 to be driven rotatably about the rotational second axis A2 of driven gear 28. As output disk 36 is driven rotatably about the second axis A2, cable 18 is pulled in cinching direction via engagement of ferrule 18a with drive end 38a of slot 38, which in turn drives ratchet 15 in cinching fashion from the secondary striker capture position to the primary striker capture position. Upon completion of cinching ratchet 15 and striker 17 captured thereby, motor 24 can be reset, thereby causing a reversal motion of driven gear 28, cycloid disk 34, and output disk 36, whereupon cable 18 and ferrule 18a thereof is permitted to return in lost motion within slot 38.

In view of the above details of operation of cinch power actuator 14, amplification of torque from motor 24 to output disk 36 can be maximized in minimal space and with minimal potential from noise due to the elimination of gear reductions and levers, and permitted by the inclusion of the simplified cycloid drive 20 discussed in detail and illustrated herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a vehicle closure member, comprising:
a cinch power actuator including a motor and a cycloidal drive; and
a latch mechanism including a ratchet and a pawl, the ratchet being moveable between a primary striker capture position, a secondary striker capture position, and a striker release position, the pawl being moveable between a ratchet holding position, whereat the pawl holds the ratchet in one of its primary and secondary striker capture positions, and a ratchet releasing position, whereat the pawl permits the ratchet to move to its striker release position,
wherein the motor is arranged to drive the cycloidal drive while the ratchet is in the secondary striker capture position, whereupon the cycloidal drive causes the ratchet to move from the secondary striker capture position to the primary striker capture position.

2. The closure latch assembly of claim 1, wherein the motor is arranged to drive a worm rotatably about a first axis and the cycloidal drive includes a driven gear configured to be driven rotatably about a second axis in response to rotation of said worm about said first axis, the cycloidal drive further including a cam configured to be driven conjointly with said driven gear in eccentric relation about said second axis.

3. The closure latch assembly of claim 2, wherein the cycloidal drive includes a cycloid disk configured to be driven in eccentric relation about said second axis in response to rotation of said cam about said second axis.

4. The closure latch assembly of claim 3, wherein said cinch power actuator has a housing including a drive pocket configured for receipt of the cycloid disk therein, said cycloid disk have a plurality of protrusions extending radially outwardly for receipt within a plurality of notches of said drive pocket.

5. The closure latch assembly of claim 4, wherein said cycloid disk is configured to rotate eccentrically within said drive pocket.

6. The closure latch assembly of claim 5, wherein said plurality of protrusions move into and out of said plurality of notches as said cycloid disk rotates eccentrically within said drive pocket.

7. The closure latch assembly of claim 5, wherein said cinch power actuator has an output disk configured to be driven about said second axis by said cycloid disk, and further including a cable operably coupling said output disk to said ratchet.

8. The closure latch assembly of claim 7, wherein said cycloid disk has a plurality of pins fixed thereto and said output disk has a plurality of openings, each of said plurality of pins being disposed in a separate one of said plurality of openings.

9. The closure latch assembly of claim 8, wherein said output disk has a slot and said cable has a ferrule fixed thereto, said ferrule being configured for lost motion within said slot as said output disk rotates about said second axis.

10. The closure latch assembly of claim 9, wherein said slot has a drive end configured to engage said ferrule to pull said cable and move said ratchet from the secondary striker capture position to the primary striker capture position.

11. A cinch power actuator for a closure latch assembly of a vehicle closure member, comprising:
a motor;
an output gear configured to be driven in response to energization of the motor;
a cam fixed to output gear for eccentric rotation about a rotational axis of output gear;
a cycloid disk configure to be driven by the cam in eccentric fashion about the rotational axis of the output gear; and
an output disk configured to be driven about the rotational axis of the output gear by the cycloid disk,
wherein the output disk is configured to drive a cable to move a ratchet of the closure latch assembly from a secondary striker capture position to a primary striker capture position.

12. The cinch power actuator of claim 11, wherein the output disk has a slot configured for receipt of a ferrule fixed to the cable therein, the ferrule being configured for lost motion within the slot as the output disk rotates about the rotational axis of the output gear.

13. The cinch power actuator of claim 12, wherein the slot has a drive end configured to engage the ferrule to pull the cable and move the ratchet from the secondary striker capture position to the primary striker capture position.

14. The cinch power actuator of claim 11, wherein the cinch power actuator has a housing including a drive pocket configured for receipt of the cycloid disk therein, the cycloid disk have a plurality of protrusions extending radially outwardly for receipt within a plurality of notches of the drive pocket.

15. The cinch power actuator of claim 11, wherein the cycloid disk has a plurality of pins fixed thereto and the output disk has a plurality of openings, each of the plurality of pins being disposed in a separate one of the plurality of openings.

16. The cinch power actuator of claim 15, wherein the openings are sized for a loose, clearance fit of the pins therein.

17. The cinch power actuator of claim 11, wherein the output disk is supported for concentric movement about the rotational axis of the output gear.

18. The cinch power actuator of claim 11, wherein the output disk is arranged between the output gear and cycloid disk.

19. The cinch power actuator of claim 18, further including a bearing supporting the cycloid disk for relative movement on the cam.

20. The cinch power actuator of claim 19, wherein the bearing rotates in eccentric fashion about the rotational axis of the output gear.
